(19) United States
(12) Patent Application Publication
(10) Pub. No.: US 2008/0317269 A1
(43) Pub. Date: Dec. 25, 2008

(54) Communication Device with Structural Part

(76) Inventors: Claus Tipsmark, Smorum (DK); Klaus L. Svendsen, Smorum (DK); Jens Lundby, Smorum (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/581,530

(22) PCT Filed: Dec. 2, 2004
(86) PCT No.: PCT/DK2004/000838

§ 371 Date: Jul. 5, 2006

(30) Foreign Application Priority Data
Dec. 5, 2003 (DK) PA 2003 01799

(51) Int. Cl. H04R 25/00

(52) U.S. Cl. 381/322

(57) ABSTRACT

The invention concerns a communication device with casing parts enclosing a microphone and a receiver and suspension points therefore in the casing. A sound canal from the receiver to the ear of a user is provided, and the casing parts are shaped from an injection moulded fibre-reinforced polymer.

### AREA OF THE INVENTION

The invention relates to a communication device with a structural part like a hearing aid or a headset. In such devices both a microphone and a receiver are provided and typically within the same casing. The receiver is provided for reproducing and presenting the audio signal picked up by the microphone to the user. Especially in hearing aids the microphone and the receiver are often placed in each others vicinity, and this may lead to serious feed back problems. When the structural parts of the device carries the audio signal from the receiver to the microphone serious limitations on the maximum output sound pressure from the receiver may be the result.

### BACKGROUND OF THE INVENTION

In hearing aids and other communication devises this problem has been dealt with in a number of ways. Firstly soft parts have been used as suspension for both receiver and microphone. Further it has been tried to enclose the receiver in an enclosure separated from the microphone. These efforts have to some degree solved the problem, but there still are limitations to the maximum output tolerated by apparatuses of this kind, before feed back problems occur.

It is further known to produce casing parts for hearing aids in titanium, but this material is difficult and expensive to shape, and thus the resulting hearing aid casing will be very expensive.

In hearing aid parts it is also possible to embed metal connections, which are to provide an electrical signal transmission path from one to the opposite side of a part. It is desirous that soldering operations are allowable on such metal connections and hereby heat resistance of the part in which the metal connection is embedded must be ensured. Heat resistance up to 270° Celsius is desired, and it is not easy to achieve with usual polymer materials.

### SUMMARY OF THE INVENTION

It is an object of the present invention to provide a communication device with casing parts, which are particularly well suited for avoiding the feed back problems of prior art communication devices and whereby the structural parts are easily shaped to form complex parts and whereby also the material has a high heat resistance.

The object of the invention is achieved with a communication device according to claim 1. By using a fibre-rich polymer material it is assured, that the feed-back problem are alleviated because the resonance frequency of the shell is raised to a much higher frequency than in a conventional polymer shell. This means that the vibration insulation of the rubber suspension will be much more effective and that the described shell vibrations leading to acoustical and mechanical feedback will be much reduced. Also the high fibre content of the material ensures elevated heat resistance, such that it becomes possible to perform solder operations in metal parts which are embedded in the material.

In an embodiment of the invention the reinforced polymer is a poluarylamide-based compound. This material has the advantage, that in injection moulding it may be caused to produce a surface layer with low fibre content, and thereby the surface quality of the moulded part will be close to the quality obtainable with materials with no fibre reinforcement. Even with a very high fibre contents this material may be caused to produce high quality surfaces. Also thin walled parts are producible with high fibre contents using this material. Thus this material is especially well suited for hearing aid and similar communication parts, where typically complex shapes must be moulded, and where further the demands to the surface appearance are very high.

In another embodiment of the invention the reinforced polymer material used for the shell is a polyamide based polymer. This material is preferred as it is easy and straight forward to process in standard moulding equipment.

In an embodiment the reinforced polymer material used has an E-module above 13 MPa. With this stiffness well functioning hearing aid shell parts may be produced. Preferably the E-module of the reinforced polymer material used is above 15 MPa, and most preferred the E-module is above 18 MPa. The mentioned E-modules referred to are according to ISO 178:2001: Plastics—Determination of flexural properties.

When the E-module of the reinforced polymer material used is above 19 MPa it becomes possible to produce hearing aid shells which are considerably thinner than usual and at the same time ensures that acoustic energy is not easily transferred from the receiver suspension and into the shell material. This is because the acoustic impedance of the shell material at suspension points should differ as much as possible from the acoustic impedance of the suspension material. This is ensured according to the invention by using a very stiff reinforced polymer material as shell part and a very flexible suspension part. Further it should be noted that the thin walls facilitated by the high E-module is an important advantage, as this allows the overall size of the hearing aid to be minimized.

In a further embodiment of the invention a receiver enclosure is provided which has wall parts forming part of the casing which in cooperation with detachable wall parts form the enclosure in an air tight manner for sound isolation of the receiver. Such a sound tight isolation of the receiver with respect to the rest of the device allows the use of a vented receiver. A receiver of this type has an orifice, which radiates sound into the enclosure, but due to the sound tightness of the enclosure this will have no effect on the microphones which are also inside the casing. When the material used for the enclosure has the added stiffness as provided by the fibre-reinforcement, the sound radiated from the receiver enclosure can be kept at a minimum value even with a very thin walled structure. Added sound isolation is preferably achieved by providing a flexible packing or gasket means between the wall part of the casing and the detachable wall part.

In an embodiment the casing comprises a first and a second part which are tightly joined along respective edge lines whereby a flexible packing or gasket material is provided in the edge line between the two casing parts. Such a packing material helps to ensure a sound tight joint between the first and the second part of the casing. Thereby it is ensured, that the rigid parts of the casing will join in a manner which provides maximum security against penetration of detrimental substances such as humidity, sweat or dust.

### BRIEF DESCRIPTION OF THE DRAWINGS

FIG. 1 shows an exploded view of a communication device according to the invention,

FIG. 2 shows the receiver assembly,

FIG. 3 shows an exploded view of the receiver with receiver suspension parts.

### DESCRIPTION OF A PREFERRED EMBODIMENT

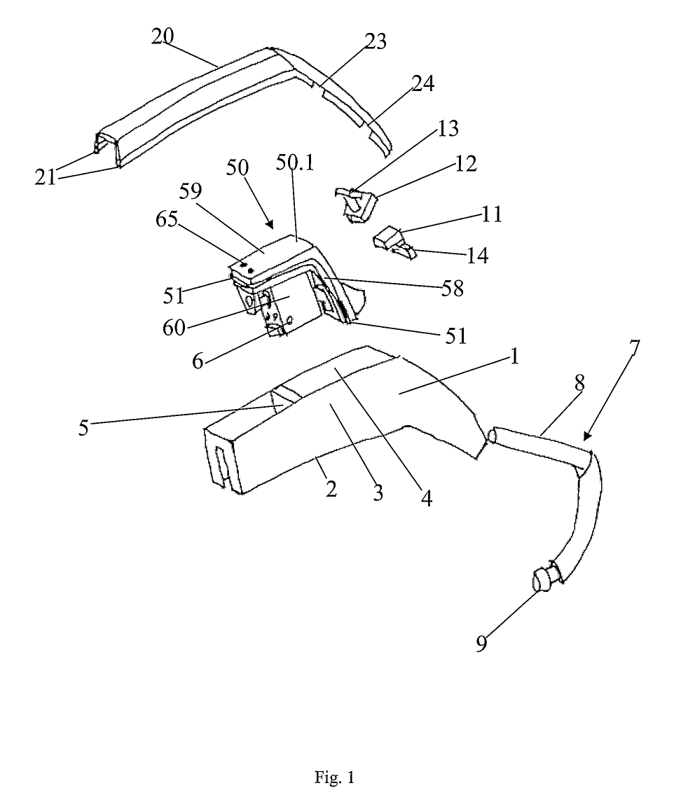

The exploded view of FIG. 1 displays the various parts of the hearing aid. The hearing aid comprises a bottom shell 1 and a top shell 20. When assembled the bottom shell 1 and the top shell 20 encloses a receiver assembly 50 and the microphones 11, 12. A hook 7 is insertable into the bottom shell 1 in order to provide a sound guide from the receiver 60 to the surroundings.

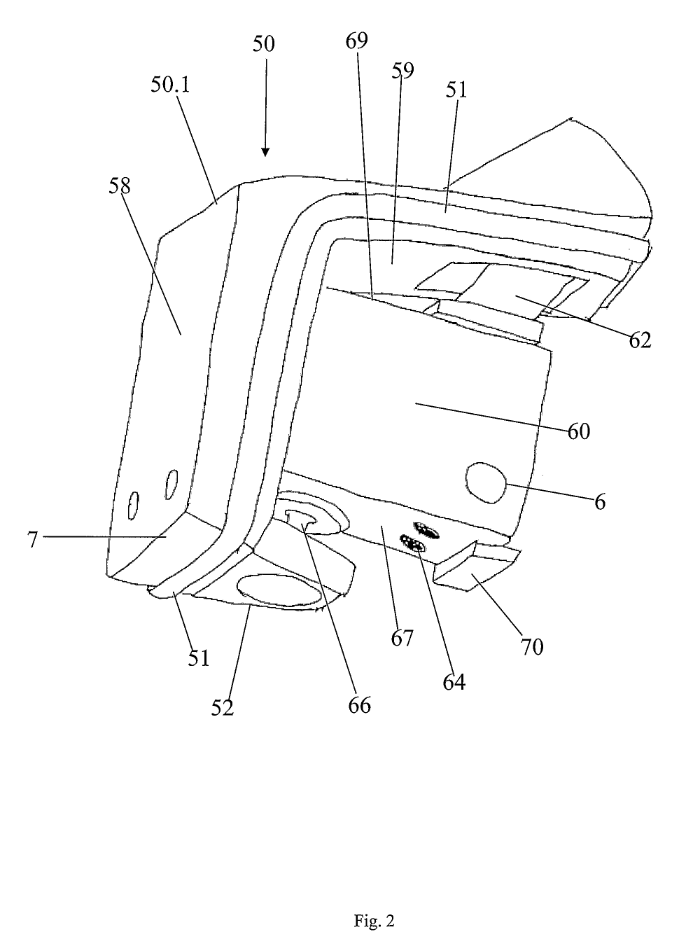

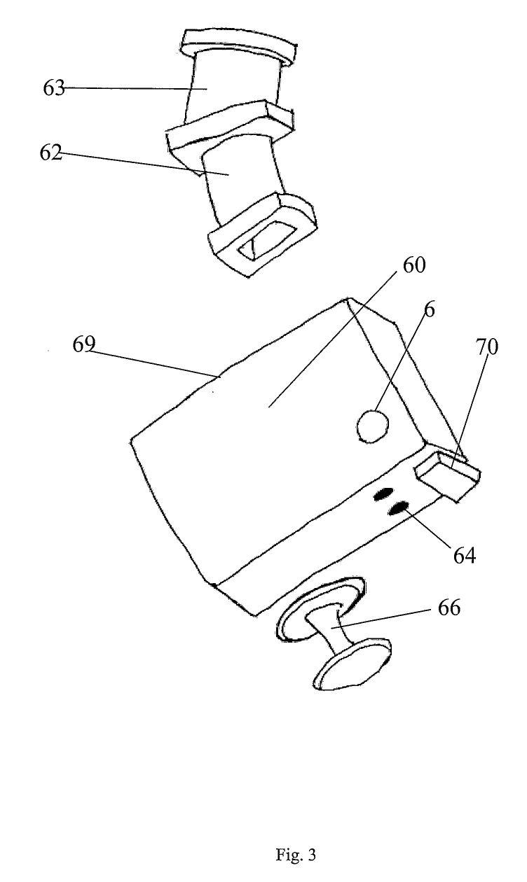

The receiver assembly 50 is described in more detail with respect to FIGS. 2 and 3. The receiver 60 has a sound outlet opening (not visible) in a first side and a flexible tube part 62 is coupled to the sound opening. The flexible tube 62 is shaped along with a tube 63 in order to form a combined sound outlet duct and receiver suspension part. At a side 67 the receiver has connection terminals 64 and also a further flexible suspension pole 66 is arranged at this side. The receiver assembly in FIG. 2 comprises the receiver 60 with suspensions 66, 62 and a receiver enclosure cover 50.1. This cover 50.1 has a first wall part 59 extending along the first side 69 of the receiver 60 and a second wall part 58 extending along the second side 68 of the receiver 60. From the second wall part 58 a beam 52 extends along the third side 67 of the receiver 60. The first wall part 59 has means for receiving and holding the tube 63, and the beam 52 has means for receiving and holding the pole 66. When the receiver is assembled to the receiver enclosure cover 50.1, the receiver is suspended by the pole 66 and the flexible tube 62. Both the tube 63 and the pole 66 extend through respective openings in the wall part 59 and the beam 52 respectively. The flexible bellows part 62 and the pole 66 are both made of a flexible polymer, such that the suspended receiver 60 may move in any direction. This helps to absorb any vibrations coming from the receiver or coming from handling the hearing aid, such that the receiver is vibrational isolated from the remaining hearing aid once assembled therewith. The high fibre contents of the shell parts 1, 20 and the receiver enclosure cover 50.1 ensures that thin wall sections can be used and at the same time no sound or vibration will be passed on from the receiver to the microphone even when a vented receiver is used.

As seen in FIGS. 2 and 3 a further shock absorbing means 70 is provided which prevents the receiver from bouncing on the internal walls of the enclosure.

In FIG. 1 it is shown how the receiver assembly may be placed in the bottom shell 1 of the hearing aid. The bottom shell comprises a bottom wall 2, two side walls 3,4 and a battery enclosure wall 5. These four walls forms together with the two walls 58, 59 of the receiver enclosure cover 50.1 a receiver cabinet whish is completely isolated from the remainder of the interior of the hearing aid. In order to achieve a sound tight seal between the wall parts of the hearing aid and the receiver enclosure cover 50. 1, the receiver enclosure cover 50.1 has a flexible sealing material 51 placed along the edges of the first and second wall parts 58, 59.

The electric connection to the receiver 60 is accomplished by use of flexible wires, which are soldered to the connection points 64 and connected to connection pins 65 embedded in the wall part 58. The high fibre contents of the material around the connection pins 65 ensures that the solder operation is possible at the surface level of the enclosure cover on both sides thereof without the melting of the surrounding material.

The hook 7 shown in FIG. 1 has a straight tube part 8 and a connection part 9. The straight tube part is to be inserted in the bottom shell 1 through an orifice and into the tube 63. In this way sound may be guided through tube 63, the straight tube part 8 and to the connection part 9. At the connection part 9 a flexible tube is to be connected to the hook in order to guide the sound to the ear of the user. Both the receiver casing and the sound path to the ear of the user are then seeled acoustically off from the remainder of the hearing aid and no sound will leak to the microphones and cause feed-back even at high output levels of the receiver. The hermetic receiver enclosure also provides the possibility to use a vented receiver. Such a receiver uses the inside of the receiver inclosure described as part of the back volume with respect to the receiver membrane and this provides the possibility of a better receiver performance. A vent opening 6 is shown in the receiver wall.

The receiver 60 and the microphones 11, 12 are connected by usual electrical circuitry (not shown) which also comprises a signal processing unit (not shown) and a battery (not shown). In the present embodiment a front microphone 11 and a back microphone 12 are shown, but one, three or more microphones may be employed. The electrical circuitry gains connection with the connection pins 65 which are embedded in the wall part 58 of the receiver enclosure cover 50.1.

The top shell 20 has and edge outline which matches the top edges of side wall 3, 4 of the bottom shell part 1. Along the edge outline of the top shell 20 a sealing material 21 is placed. This sealing material 21 is interrupted at places 23, 24 in order that the microphone inlets 13, 14 of the microphones 11, 12 may gain access to the surrounding. As seen in FIG. 1 the microphones 11, 12 are placed symmetrically in the centre of the hearing aid and the microphone inlets 13, 14 are open to both sides of the hearing aid, and thus the interruptions 23, 24 in the sealing material 21 of the top shell 20 are provided at both sides to accommodate the microphone inlets. In this way both the top-shell 20 and the microphone inlets 13, 14 will have the same shape for both right and left side hearing aids. If wished, the microphone inlets pointing towards the users head when the hearing aid is placed on the ear may be filled out with a plug of suitable material. This can happen at the production facility or at the final dispenser, who sells the hearing aid to the end-user. Having the microphone inlets placed in the sealing line between the two shell parts has the further advantage, that when the two shell parts are pressed together a tight seal is obtained between the microphone inlets and the shell parts. This aid to avoid the penetration into the hearing aid of contaminating substances such as sweat or dust which otherwise could damage the delicate electronic parts of the hearing aid. This further aids to prevent sounds generated by the receiver inside the hearing aid casing to leak into the sound inlet openings of the microphones. The two packing lines: the line between the two shell parts and the line between the receiver enclosure cover together assures, that no sound will leak from the receiver and through the air reach the microphones. The high rigidity of the fibre reinforced parts will help to ensure that the packing means between the parts provide complete sound and air tight joints. Also the placement of the microphone inlets in the packing material renders the microphone inlets less visible which lends more possibilities for agreeable designs of the hearing aid.

Preferably the sealing material at the sealing lines 51 and 21 are applied in a multi component injection moulding technique.

The receiver sub assembly 50 of FIG. 2 is produced and may easily be placed in the bottom shell 2 as seen from FIG. 1. The receiver sub assembly 50 may be held in place by suitable and well known click connections (not shown). Placement of the receiver 60 with suspensions 66, 62 in the receiver assembly cover 50.1 is done by drawing the tube 63 through the hole in the wall part 59 and likewise placing the pole 66 through the hole or slot in the beam 52. If the receiver should malfunction it is easily exchanged. This is done simply by lifting the receiver assembly cover 50.1 out of the hearing aid and removing the connection wires from their connection points with the receiver. Thereafter the receiver is easily removed from the receiver assembly cover, and a new receiver can be manually inserted to take its place. Soldering the connection wires to the new receiver is a formality.

1. Communication device with casing parts enclosing a microphone and a receiver and suspension points therefore in the casing, further including a sound canal from the receiver to the ear of a user, and wherein at least one of the casing parts are shaped from an injection moulded fibre-reinforced polymer which has a fibre content between 30% and 75% by weight.

2. Communication device as claimed in claim 1, whereby the fibre content is between 40% and 60% by weight.

3. Communication device as claimed in claim 1, whereby the reinforced polymer is ‘a polymylamide-based compound and the fibre-reinforcement comprises glass fibres.

4. Communication device as claimed in claim 1, wherein the reinforced polymer is a polyamide-based compound.

5. Communication device as claimed in claim 1, wherein the reinforced polymer compound has an B-module which is higher than 13 MPa.

6. Communication device as claimed in claim 1, wherein the reinforced polymer compound has an B-module which is higher than 15 MPa.

7. Communication device as claimed in claim 1, wherein the reinforced polymer compound has an B-module which is higher than 18 Mpa.

8. Communication device as claimed in claim 1, including a receiver enclosure which has wall parts forming part of the casing which in cooperation with detachable wall parts form the enclosure in an air tight manner for sound isolation of the receiver.

9. Communication device as claimed in claim 8, wherein at least shell and wall parts forming the receiver enclosure are shaped from an injection moulded fibre-reinforced polymer.

10. Communication device as claimed in claim 1, wherein the casing comprises a first and a second part which are tightly joined along respective edge lines whereby a flexible packing or gasket material is provided in the edge line between the two casing parts.
